(19) United States
(12) Patent Application Publication
(10) Pub. No.: US 2004/0246141 A1
(43) Pub. Date: Dec. 9, 2004

(54) Methods and apparatus for through tubing deployment, monitoring and operation of wireless systems

(76) Inventors: Paulo S. Tubel, The Woodlands, TX (US); Charles A. Cantrelle, The Woodlands, TX (US); Scott L. Kruegel, The Woodlands, TX (US); Clarks J. Bergeron, The Woodlands, TX (US)

Correspondence Address: DUANE, MORRIS, LLP, 3200 SOUTHWEST FREEWAY, Suite 3150, HOUSTON, TX, 77027, US

(21) Appl. No.: 10/860,263

(22) Filed: Jun. 3, 2004

Related U.S. Application Data
(60) Provisional application No. 60/475,441, filed on Jun. 3, 2003.

(51) Int. Cl. G01V 3/00

(52) U.S. Cl. 340/854.3

(57) ABSTRACT

A device, system, and methods of use for wireless transmission of a detected parameter obtained from inside a wellbore is disclosed. The wireless device comprises an acoustic wireless transceiver and a selectively expandable acoustic coupler operatively in communication with the acoustic wireless transceiver, the acoustic coupler adapted to physically couple the acoustic wireless transceiver with an interior of a tubular and acoustically transmit and/or receive data. The wireless monitoring device is deployed through a tubular to a predetermined position within the tubular, a predetermined portion physically coupled to the tubular once the monitoring device reaches the predetermined position, and data transmission acoustically coupled between the monitoring device and a remote receiver through the tubular. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### PRIORITY INFORMATION

This application claims the benefit of U.S. Provisional Application No. 60/474,486 filed on Jun. 3, 2003.

### FIELD OF THE INVENTION

The inventions are related to hydrocarbon production monitoring. More specifically, the inventions relate to a device, system, and methods of providing wireless transmission in a tubular as may be used in a hydrocarbon producing well using tubing as a transmission medium to remotely monitor downhole parameters, thereby aiding optimization of the hydrocarbon production over the life of the well by deploying the device through the existing tubing.

### BACKGROUND OF THE INVENTION

The rework costs and risks associated with the removal of tubing from inside the wellbore is in some cases too great for low hydrocarbon producing wells and those wells may cease production because of these costs. Also, the inability to accurately monitor formation and production parameters causes the production of hydrocarbons to be inefficient and in some cases cause the cost of lifting the hydrocarbon uneconomical.

The devices used in the wellbore in the past have been deployed in line with tubing only. Getting data and/or commands transmitted between the surface and one or more devices located in the tubulars, i.e. downhole, is a difficult and costly task, often involving running wires and/or fiber optic data transmission media downhole.

It is therefore desirable to provide some means for a hydrocarbon producing well to remotely monitor downhole parameters to monitor, e.g. help optimize, the hydrocarbon production over the life of the well by deploying a device through existing tubing and communicating with that device using no additional cables or wires.

### BRIEF DESCRIPTION OF THE DRAWINGS

The features, aspects, and advantages of the present invention will become more fully apparent from the following description, appended claims, and accompanying drawings in which:

FIG. 1 is a schematic block diagram of an exemplary system;

FIG. 2 is a flowchart of a first exemplary method; and

FIG. 3 is a flowchart of a second exemplary method.

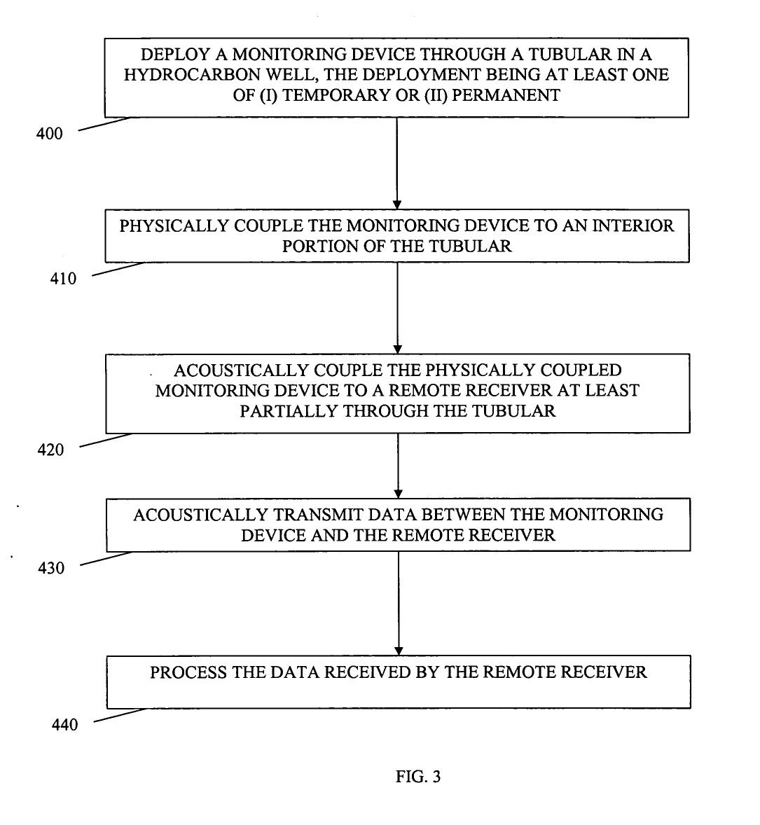

### DETAILED DESCRIPTION OF EXEMPLARY EMBODIMENTS

These inventions provide means useful in a hydrocarbon producing well to remotely monitor downhole parameters to optimize the hydrocarbon production over the life of the well by deploying an acoustic wireless device through existing tubing. These inventions comprise a device to measure parameters inside the wellbore and transmit the information in real time using wireless communications methods and may be deployed via coil tubing, slickline, or electric line without the need to pull tubing from inside the wellbore.

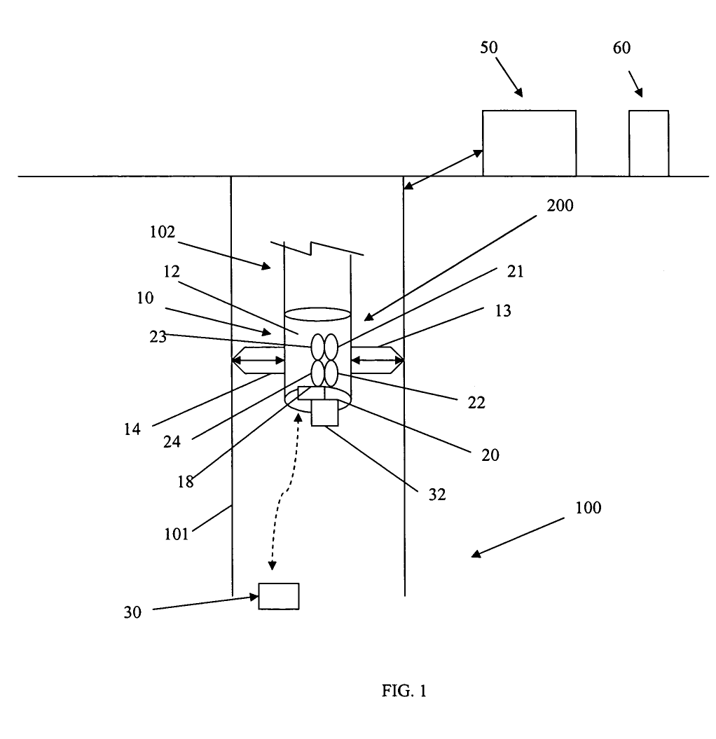

Referring to FIG. 1, wireless transmission device 10 is adapted to provide a detected parameter obtained from inside wellbore 100 and transmit the information using a wireless communications method, e.g. to receiver 50. In a preferred embodiment, wireless transmission device 10 comprises acoustic wireless transceiver 20 and one or more selectively expandable acoustic couplers 13,14 which are operatively in communication with acoustic wireless transceiver 20. Acoustic couplers 13,14 are adapted to physically couple acoustic wireless transceiver 20 with an interior of tubular 101 and enable acoustic transmission of data. As used herein, transmission encompasses both sending and receiving data and a transceiver is a device capable of transmitting, receiving, or both transmitting and receiving data.

Wireless transmission device 10 comprises housing 12 and may further comprise one or more sensors 30.

Housing 12 may comprise a pressure vessel adapted to house one or more of data processor 21, acoustic transceiver 22 operatively in communication with data processor 21, and sensor 30 operatively in communication with data processor 21. Pressure vessel 12 may be adapted to moveably fit within tubular 101.

Acoustic transceiver 22 may be adapted to drive a piezoelectric assembly for transmission of acoustic signals between acoustic transceiver 22 and the surface, e.g. receiver 50, using tubular 101 as a transmission medium. Acoustic transceiver 22 may comprise a data and control communications transceiver.

Low power microprocessor 18 may be present and disposed within housing 12 where low power microprocessor 18 is adapted for control and communications of wireless transmission device 10. Data processor 21 may comprise low power microprocessor 18 or a separate processor. Data processor 21 may further comprise memory, e.g. a transient data store such as random access memory or a persistent data store or a combination thereof.

Sensor 30 may be disposed at least partially within housing 12, totally within housing 12, or totally outside housing 12. Data generated by or otherwise present in sensors 30 will be converted into acoustic information and transmitted through tubing 101 to the surface.

Sensor 30 may further be operatively in communication with acoustic wireless transceiver 20 and may be adapted to detect a characteristic of a formation in or proximate to which sensor 30 is disposed. Sensor 30 may comprise a casing collar locator, a gamma ray detector to determine the location of device string 102 in well 100, a sensor adapted to detect a characteristic of the formation, or the like, or a combination thereof. These characteristics of the formation may comprise pressure, temperature, or the like, or a combination thereof.

Sensor 30 may be deployed as part of device string 102 as one or more built in sensors or may be deployed external to acoustic device 10 and, in certain configurations, attached to acoustic device 10 such as via cables.

Selectively expandable acoustic couplers 13,14 may comprise a slip disposed at least partially on an outside of wireless transmission device 10. Alternatively, selectively expandable acoustic couplers 13,14 may comprise an expansion device such as a packer, a ring, an expandable mesh, or the like, or a combination thereof. Selectively expandable acoustic couplers 13,14, e.g. one or more slips, may be present and adapted to selectively secure pressure vessel 12 against an interior of a tubular and couple an acoustic signal from acoustic transceiver 21 to tubing 101.

As further illustrated in FIG. 1, downhole wireless system, generally referred to herein by the numeral “200,” may comprise wireless device 10 as described herein above and surface processor 50 adapted to obtain and process data obtained acoustically tubular 101 as a transmission medium from downhole or a surface sensor.

Power converter 23 and data acquisition module 24 may be disposed within or proximate housing 12.

Downhole gauge 32 may also be present and operatively in communication with data processor 21, e.g. either wirelessly, via wires, or via a local bus within housing 12. As illustrated in FIG. 1, gauge 32 may be at least partially disposed in housing 12 or may be independent of wireless device 10, e.g. a wireless gauge.

In the operation of exemplary embodiments, in order to restore the production of the well completion it has heretofore been a common practice to pull the entire length of production tubing out of the casing to clear obstructed tubing perforations or replace the perforated tubing section and then re-install the production tubing within the casing. As is well known, this is a laborious, time-consuming, and expensive task.

A system, e.g. as illustrated in FIG. 1, comprising the present inventions may use electronics, sensors and acoustic generators to acquire production and formation data to optimize hydrocarbon production. As an example, the ability to optimize the production of hydrocarbons when using an artificial lift system is essential to reduce the amount of energy required to lift the hydrocarbon. Today, this task is performing by automatically timing at the surface when the artificial lift system should be turned on and off, and in some cases echometers are used at the surface to determine fluid level.

A system comprising the present inventions may be used to create a wireless communications system that may be deployed either temporarily or permanently, e.g. for through tubing service to obtain fluid level information for optimization of the artificial lifting process. The system may also be retrieved from inside the wellbore without requiring that the tubing be pulled from the well. Such a system may be used to address a problems that exist today in oilfields by providing a solution to service, e.g. temporary, and permanent applications. Such as system may be used in the following exemplary ways:

1. Reservoir pressure monitoring—system 200 may be deployed permanently inside the wellbore to monitor formation pressure for reservoir analysis and optimum pressure drawdown.

2. Build up tests—wireless device 10 may be deployed in wells through tubing 101 for monitoring pressure when the well is shut in. The build up of the pressure in the well may provide information related to the reservoir status and formation ability to produce the hydrocarbon. The real time data may reduce the time that it takes to perform a build up test so that the well may be back on line producing hydrocarbons quicker.

3. Gravel pack and frac pack—this service application may be performed by placing wireless device 10 in a washpipe and deploying wireless device 10 as part of a work string to perform a gravel or frac pack or a frac job. Wireless device 10 will transmit the data through the washpipe to the surface, e.g. to receiver 50. Wireless device 10 may utilized multiple gauges deployed in the well and in the washpipe internal and external to wireless device 10, e.g. pressure and temperature sensors 30 and others such as strain gauges 32 and flow meters 34 to determine if the process is being done properly and the fluids are going to the intended location in the formations.

4. Artificial lift optimization—Production pressure from a wireless retrievable gauge 32 may be transmitted in real time to provide a fluid level indication for optimization of the artificial lift process.

5. Gravel pack rework—wireless device 10 may be used to seal existing tubing and set the path for the surface gravel into the old gravel pack as well as to monitor the pressure and temperature downhole to assure that the gravel is reaching its destination.

6. Coil tubing applications—wireless device 10 may be interfaced with a coil tubing for transmission of data in real time through the coil tubing for processing at the surface. Wireless device 10 may have multiple sensors such as a casing collar locator and/or a gamma ray detector to determine the location of device string 102 in the well and also the characteristics of the formation. Pressure and temperature sensors 30 may also be deployed as part of device string 102 as built in sensors 30 or sensors 30 external to wireless device 10 but attached to wireless device 10 via cables where the data from external sensors 30 will be converted into acoustic information and transmitted through the coil tubing to the surface.

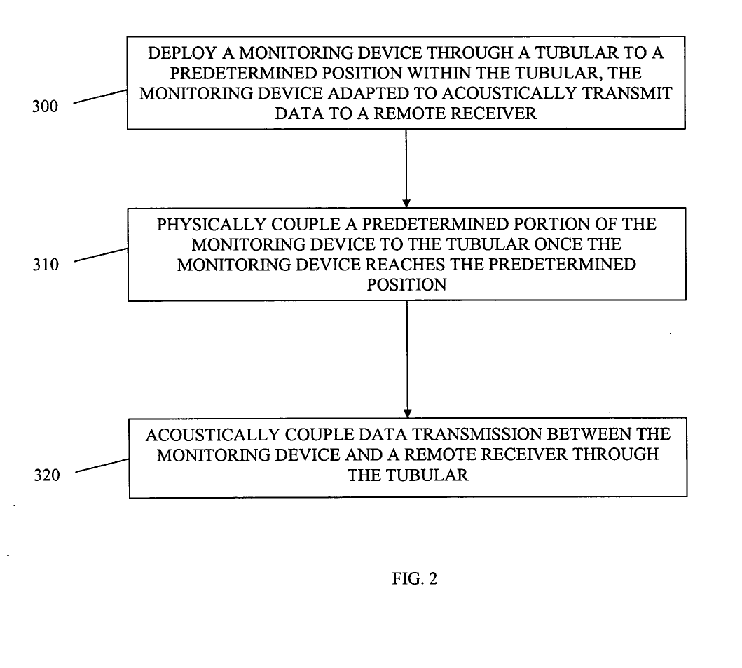

Referring now to FIG. 2, acoustic transmission of data in tubular 101 may be provided by deploying wireless device 10 (FIG. 1) through tubular 101 (FIG. 1) to a predetermined position within tubular 101 where wireless device 10 is adapted to acoustically transmit data to remote receiver 50 (FIG. 1) (step 300). A predetermined portion of monitoring device 10 may be physically coupled to tubular 101 once monitoring device 10 reaches the predetermined position within tubular 101 (step 310). Once physically coupled, data transmission such as from acoustic transceiver 22 (FIG. 1) may be acoustically coupled from monitoring device 10 to remote receiver 50 through tubular 101 using the physical coupling (step 320).

Deploying monitoring device 10 may comprise either permanent or temporary and may be accomplished using a slick line, a coiled tubing, an electric line, or the like, or a combination thereof.

Physical coupling of monitoring device 10 to tubular 101 may be physically engaging a portion of monitoring device 10, e.g. selectively expandable acoustic couplers 13,14 (FIG. 1), with an interior surface of tubular 101 when monitoring device 10 is positioned to the predetermined position within tubular 101. In an embodiment, monitoring device 10 or a portion thereof, e.g. selectively expandable acoustic couplers 13,14, is secured to the interior surface of tubular 101 and disengaged from the interior surface of tubular 101 when monitoring device 101 is to be repositioned within the tubular, e.g. removed from within tubular 101 or merely repositioned to another location within tubular 101.

Monitoring device 10 may be adapted to obtain data representative of a local parameter and/or process data representative of the local parameter.

Sensor 30 (FIG. 1) may be deployed, either as part of monitoring device or external to monitoring device 10. Further, sensor 30 may be deployed downhole, within tubular 101, or proximate or at the surface. Sensor 30 may transmit and/or receive data with respect to monitoring device 10. This data transmission may be via wires, wireless, or via a local bus.

In certain embodiments, the data transmission may further comprise a data transmission identifier.

Referring now to FIG., 3, in a further exemplary embodiment, data may be obtained from within tubular 101 (FIG. 1) by deploying monitoring device 10 (FIG. 1) through tubular 101 in a hydrocarbon well, where the deployment is either temporary or permanent (step 400). Monitoring device 10 may be physically coupled to an interior portion of tubular 101 (step 410). The physically coupled monitoring device 10 may then be acoustically coupled to remote receiver 50 at least partially through tubular 101 (step 420). Data may then be acoustically transmitted between monitoring device 10 and remote receiver 50 (step 430). Data received by remote receiver 50 (FIG. 1) may be processed by remote receiver 50 (step 440).

Additionally, processed data may be transmitted between remote receiver 50 and data processor 60 (FIG. 1) such as by a local bus, an RS-232 connection, a local area networking connection, a cellular telephony connection, a satellite data transmission connection, or the like, or a combination thereof. Data processor 60 may be integral with remote receiver 50 or it may comprise a separate module within remote receiver 50 or external to remote receiver 50, e.g. a personal computer.

Acoustically transmitted data may be transmitted either on-demand, continuously, at scheduled intervals, or via a master-slave configuration wherein monitoring device 10 waits for the surface system, e.g. receiver 50, to address a specific device prior to a function being performed by that device.

Data may be processed in real time and may further be displayed on a display located at a surface location, e.g. receiver 50 or data processor 60.

Monitoring device 10 may be inserted through tubing 101 deployed in situ.

Physically coupling comprises using one or more mechanical couplers adapted to expand or retract a portion of monitoring device 10, e.g. selectively expandable acoustic couplers 13,14 (FIG. 1). These mechanical couplers may further be adapted to couple an acoustic signal to acoustic receiver 22 disposed within housing 12.

Monitoring may comprise formation evaluation or production parameters monitoring. Additionally, transmitted data may be used to optimize hydrocarbon production over the life of the well. Monitoring may further comprise monitoring a physical characteristic usable by a pressure buildup test, monitoring a physical characteristic usable during a gravel pack operation, monitoring a physical characteristic usable during a during frac pack operation, monitoring a physical characteristic usable during an artificial lift operation, monitoring a physical characteristic usable by a coil tubing application, or the like, or a combination thereof.

For build up tests, monitoring device 10 may be deployed in wells through tubing for monitoring pressure when the well is shut in.

For a gravel pack or frac pack operation, monitoring device 10 may be disposed in a washpipe and deployed as part of a work string to perform the gravel pack or frac pack operation. As used herein, sensors 30 may be disposed in the washpipe and interface via cable to wireless device 10 which may itself be housed in the washpipe.

Data may be transmitted at least partially through the washpipe to a surface location. Gauge 32 (FIG. 1) may be provided along with or within monitoring device 10 and deployed to be in communication with monitoring device 10, e.g. deployed in the well or the washpipe. As used herein, gauge 32 may comprise a pressure sensor, a temperature sensor, a strain gauge, a flow meter, or the like, one or more of which may be adapted to determine if a process is occurring properly, e.g. fluids are going to the intended location in the formations.

Gravel pack operations may comprise using monitoring device 10 to seal tubular 101 and set the path for surface gravel into an existing gravel pack. Monitoring device 10 may be used to assure that the gravel is reaching its destination by monitoring downhole pressure or downhole temperature.

For artificial lift optimization, a wireless retrievable gauge, e.g. gauge 32 in FIG. 1, may be deployed to be in communication with monitoring device 10. Wireless retrievable gauge 32 may be adapted to determine a production pressure to provide a fluid level indication for optimization of the artificial lift process, e.g. wherein acquired fluid level information is useful for optimization of the artificial lifting process.

For coil tubing applications, wireless device 10 may be interfaced with a coil tubing for transmission of data in real time through the coil tubing for processing at the surface. Wireless device 10 may further comprise a plurality of sensors 30. The plurality of sensors 30 may be deployed as part of device string 102 (FIG. 1) and may comprise sensors 30 internal to wireless device 10 and sensors external to wireless device 10. External sensors 30 may be attached to wireless device 10 via cables.

Sensors 30 may comprise a sensor adapted to determine a location of device string 102 in the well or a characteristic of the formation, e.g. pressure or temperature.

Using system 200, a predetermined parameter indicative of a physical condition of the hydrocarbon well may be monitored and control, command, and communication functionality provided between monitoring device 10 and remote receiver 50, e.g. using a microprocessor or a digital signal processor or the like or a combination thereof. The control, command, and communication functionality may be directed through monitoring device 10 to a downhole device, e.g. sensor 30, and comprise control or commands directed to that downhole device, e.g. an actuation command, a request for the modification of a state, a change in a status, or the like, or a combination thereof.

Remote receiver 50 may be located at the surface of the hydrocarbon well and acoustically transmitted data transmitted from remote receiver 50 where the data further comprise a command to a single monitoring device 10, a command to a plurality of monitoring devices 10, non-command data, or the like, or a combination thereof.

A health monitor feature may be provided and the health monitor function is at least partially implemented within monitoring device 10 to check the status of a component of monitoring device 10. Further, a shut down and sleep mode for monitoring device 10 may be provided, e.g. to reduce power consumption for work when monitoring device 10 is permanently deployed.

It will be understood that various changes in the details, materials, and arrangements of the parts which have been described and illustrated above in order to explain the nature of this invention may be made by those skilled in the art without departing from the principle and scope of the invention as recited in the following claims.

We claim:

1. A method of providing acoustic transmission of data in tubular, comprising:
a. deploying a monitoring device through a tubular to a predetermined position within the tubular, the monitoring device adapted to acoustically transmit data to a remote receiver;
b. physically coupling a predetermined portion of the monitoring device to the tubular once the monitoring device reaches the predetermined position; and
c. acoustically coupling data transmission between the monitoring device and a remote receiver through the tubular.

2. The method of claim 1, wherein deploying the monitoring device is at least one of (i) a permanent deployment or (ii) a temporary deployment.

3. The method of claim 1, wherein deploying the monitoring device further comprises using at least one of (i) a slick line, (ii) a coiled tubing, or (iii) an electric line.

4. The method of claim 1, wherein physically coupling the monitoring device to the tubular further comprises physically engaging a portion of the monitoring device with an interior surface of the tubular when the monitoring device is positioned to the predetermined position within the tubular.

5. The method of claim 4, further comprising:
a. securing the monitoring device to the interior surface of the tubular using the portion of the monitoring device; and
b. disengaging the portion of the monitoring device from the interior surface of the tubular when the monitoring device is to be repositioned within the tubular.

6. The method of claim 5, wherein the disengaging occurs when the monitoring device is to be repositioned within the tubular.

7. The method of claim 5, wherein the portion of the monitoring device comprises a slip adapted to selectively engage the interior surface of the tubular by the monitoring device to secure the monitoring device to the interior surface of the tubular.

8. The method of claim 1, wherein the monitoring device is adapted to at least one of (i) obtain data representative of a local parameter or (ii) process data representative of a local parameter.

9. The method of claim 1, further comprising:
a. deploying a sensor; and
b. transmitting data between the sensor and the monitoring device.

10. The method of claim 9, wherein the transmitting data between the sensor and the monitoring device is wireless.

11. The method of claim 1, wherein the data transmission further comprises a data transmission identifier.

12. A system for transmission of data from within a tubular, comprising:
a. deploying a monitoring device through a tubular in a hydrocarbon well, the deployment being at least one of (i) temporary or (ii) permanent;
b. physically coupling the monitoring device to an interior portion of the tubular;
c. acoustically coupling the physically coupled monitoring device to a remote receiver at least partially through the tubular;
d. acoustically transmitting data between the monitoring device and the remote receiver; and
e. processing the data received by the remote receiver.

13. The method of claim 12, further comprising transmitting processed data between the receiver and a data processor using at least one of (i) a local bus, (ii) an RS-232 connection, (iii) a local area networking connection, (iv) a cellular telephony connection, or (v) a satellite data transmission connection.

14. The method of claim 12, wherein acoustically transmitting data comprises at least one of (i) continuous data transmission or (ii) a master-slave configuration wherein the monitoring device waits for the remote receiver to address a specific monitoring device prior to a function being performed by the monitoring device.

15. The method of claim 12, further comprising:
a. monitoring a predetermined parameter indicative of a physical condition of the hydrocarbon well; and
b. providing control, command, and communication functionality between the monitoring device and the remote receiver using at least one of (i) a microprocessor or (ii) a digital signal processor.

16. The method of claim 15, wherein the control, command, and communication functionality is directed to a downhole device, the control, command, and communication functionality further comprising at least one of (i) an actuation command, (ii) a modification of a state, or (iii) a change in a status.

17. The method of claim 15, wherein:
a. the remote receiver is located at the surface of the hydrocarbon well; and
b. the acoustically transmitted data is transmitted from the remote receiver, the data further comprising at least one of (i) a command to a single monitoring device, (ii) a command to a plurality of monitoring devices, or (iii) non-command data.

18. The method of claim 12, further comprising providing a health monitor feature at least partially implemented within the monitoring device to check the status of a component of the monitoring device.

19. The method of claim 12, further comprising providing a shut down and sleep mode for the monitoring device to reduce power consumption for work when the monitoring device is permanently deployed.

20. The method of claim 12, wherein:
a. the monitoring device is inserted through tubing deployed in situ; and
b. physically coupling further comprises using a mechanical coupler adapted to expand or retract a portion of the monitoring device, the mechanical coupler further adapted to couple an acoustic signal to a receiver mounted in the monitoring device when the monitoring device is physically coupled to the tubular.

21. The method of claim 15, wherein the monitoring comprises at least one of (i) formation evaluation or (ii) production parameters monitoring.

22. The method of claim 12, further comprising:
a. processing the data in real time; and
b. displaying the processed data on a display located at a surface location.

23. The method of claim 12, further comprising using the transmitted data to optimize hydrocarbon production over the life of the hydrocarbon well.

24. The method of claim 12, wherein the monitoring further comprises monitoring a physical characteristic usable by at least one of (i) a pressure buildup test, (ii) a gravel pack operation, (iii) a frac pack operation, (iv) an artificial lift operation, or (v) a coil tubing application.

25. The method of claim 24, wherein, for build up tests, the monitoring device is deployed in a hydrocarbon well through tubing for monitoring pressure when the hydrocarbon well is shut in.

26. The method of claim 24, wherein for either a gravel pack or frac pack operation, the method further comprises:
a. positioning the monitoring device in a washpipe;
b. deploying the monitoring device as part of a work string to perform the gravel pack or frac pack operation; and
c. acoustically transmitting the data at least partially through the washpipe to a surface location.

27. The method of claim 26, further comprising deploying a gauge in communication with the monitoring device, the gauge deployed in at least one of (i) the well or (ii) the washpipe.

28. The method of claim 27, wherein the gauge is disposed at least partially within the monitoring device.

29. The method of claim 27, wherein the gauge comprises at least one of (i) a pressure sensor, (ii) a temperature sensor, (iii) a strain gauge, or (iv) a flow meter adapted to determine if the process is being done properly and the fluids are going to the intended location in the formations.

30. The method of claim 24, for the artificial lift operation, further comprising deploying a wireless retrievable gauge in communication with the monitoring device, the wireless retrievable gauge adapted to determine a production pressure to provide a fluid level indication for optimization of the artificial lift process.

31. The method of claim 30, wherein fluid level information is acquired useful for optimization of the artificial lifting process.

32. The method of claim 24, for the gravel pack operation, further comprising:
a. using the monitoring device to seal the tubular and set the path for surface gravel into an existing gravel pack; and
b. using the monitoring device to assure that gravel is reaching its destination by monitoring at least one of (i) downhole pressure of (ii) downhole temperature.

33. The method of claim 24, for coil tubing applications, wherein:
a. the wireless device is interfaced with a coil tubing for transmission of data in real time through the coil tubing for processing at the surface; and
b. the wireless device further comprises a plurality of sensors.

34. The method of claim 33, wherein the plurality of sensors are deployed as part of a device string and comprise at least one of (i) a sensor internal to the wireless device and (ii) a sensor external to the wireless device.

35. The method of claim 34, wherein the external sensor is attached to the wireless device via a cable.

36. The method of claim 33, the plurality of sensors further comprise a sensor adapted to determine at least one of (i) a location of a device string in the well or (ii) a characteristic of the formation.

37. The method of claim 36, wherein the sensor further comprises at least one of (i) a casing collar locator, (ii) a gamma ray detector, (iii) a pressure sensor, or (iv) a temperature sensor.

38. The method of claim 36, wherein the characteristic comprises at least one of (i) pressure or (ii) temperature.

39. A wireless transmission device adapted to provide a detected parameter obtained from inside a wellbore and transmit the information using a wireless communications method, comprising:
a. an acoustic wireless transceiver; and
b. a selectively expandable acoustic coupler operatively in communication with the acoustic wireless transceiver, the acoustic coupler adapted to physically couple the acoustic wireless transceiver with an interior of a tubular and acoustically communicate data.

40. The wireless transmission device of claim 39, further comprising:
a. a housing adapted to contain the acoustic wireless transceiver; and
b. a sensor disposed at least partially within the housing, the sensor operatively in communication with the acoustic wireless transceiver and adapted to detect a characteristic of a formation.

41. The wireless transmission device of claim 40, wherein the sensor further comprises at least one of (i) a casing collar locator, (ii) a gamma ray detector adapted to determine the location of the device string in the well, or (iii) a sensor adapted to detect a characteristic of the formation.

42. The wireless transmission device of claim 41, wherein the characteristic of the formation is at least one of (i) pressure or (ii) temperature.

43. The wireless transmission device of claim 40, wherein the sensor further comprises a sensor deployed as part of a device string as a built in sensor or external to the acoustic device but attached to the wireless transmission device via a cable where data from the sensor will be converted into acoustic information and transmitted acoustically through tubing to the surface.

44. The wireless transmission device of claim 39, wherein the selectively expandable acoustic coupler comprises a slip disposed at least partially on an outside of the wireless transmission device.

45. A downhole wireless system, comprising:
a. a wireless acoustic transmission device, further comprising:
i. a pressure vessel adapted to house a data processor, an acoustic transceiver operatively in communication with the data processor, and a sensor operatively in communication with the data processor, the pressure vessel adapted to moveably fit within a tubular; and
ii. a selectively expandable acoustic coupler adapted to selectively secure the pressure vessel against an interior of a tubular and couple an acoustic signal from the acoustic transceiver to the production tubing; and
b. a surface processor adapted to obtain and process data obtained acoustically using the tubular as a transmission medium from at least one of (i) downhole or (ii) a surface sensor.

46. The downhole wireless system of claim 45, further comprising:
a. a power converter; and
b. a data acquisition module.

47. The downhole wireless system of claim 45, wherein the acoustic transceiver comprises a data and control communications transceiver.

48. The downhole wireless system of claim 45, further comprising a downhole gauge operatively in communication with the data processor.

49. The downhole wireless system of claim 45, further comprising a low power microprocessor for control and communications of the downhole device.

50. The downhole wireless system of claim 45, wherein:
a. the data processor further comprises memory; and
b. the acoustic transceiver is adapted to drive a piezoelectric assembly for transmission of acoustic signals between the acoustic transceiver and the surface using the tubular as a transmission medium.
